(19) United States
(12) Patent Application Publication
(10) Pub. No.: US 2023/0114506 A1
(43) Pub. Date: Apr. 13, 2023

(54) SYSTEM FOR ON-DEMAND DIMINISHED REALITY REPLACEMENTS FOR CROWD VIEWING

(71) Applicant: AT&T Intellectual Property I, L.P., Atlanta, GA (US)

(72) Inventor: Eric Zavesky, Austin, TX (US)

(73) Assignee: AT&T Intellectual Property I, L.P., Atlanta, GA (US)

(21) Appl. No.: 17/498,825

(22) Filed: Oct. 12, 2021

(51) Int. Cl. G06T 11/00

(52) U.S. Cl. CPC G06T 11/00

(57) ABSTRACT

Aspects of the subject disclosure may include, for example a system for deploying diminished reality content. An occurrence of an event may be detected, diminished reality content may be determined, a delivery channel for the diminished reality content may be determined, and the diminished reality content may be deployed in the delivery channel. Other embodiments are disclosed.

### FIELD OF THE DISCLOSURE

The subject disclosure relates to systems that modify a perception of reality.

### BACKGROUND

The occurrence of an unexpected event (e.g., a roadside car crash, damage to a building, construction on a sidewalk) may cause problems such as traffic congestion, distracted participants (e.g. drivers, pedestrians) and may thereby cascade issues in an area that need attention from external parties (e.g., police, repair crew, electrical crews).

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating operation of an example, non-limiting embodiment of a diminished reality system in accordance with various aspects described herein.

FIG. 2B is a block diagram illustrating an example, non-limiting embodiment of a diminished reality system with multiple sensors in accordance with various aspects described herein.

FIG. 2C is a block diagram illustrating an example, non-limiting embodiment of a diminished reality system with multiple delivery channels for diminished reality content in accordance with various aspects described herein.

FIGS. 2D-2F are block diagrams illustrating additional example, non-limiting embodiments of diminished reality systems in accordance with various aspects described herein.

FIG. 2G is a diagram illustrating operation of example, non-limiting embodiments of diminished reality systems in accordance with various aspects described herein.

FIG. 2H depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for deploying diminished reality content. Other embodiments are described in the subject disclosure.

One or more aspects of the subject disclosure include a device comprising a processing system including a processor, and a memory that stores executable instructions that, when executed by the processing system, facilitate performance of operations. The operations may include: detecting an occurrence of an event; determining diminished reality content that, when displayed, will diminish a reality of the event; determining a delivery channel for the diminished reality content; and deploying the diminished reality content in the delivery channel to diminish the reality of the event.

One or more aspects of the subject disclosure include a non-transitory, machine-readable medium, comprising executable instructions that, when executed by a processing system including a processor, facilitate performance of operations. The operations may include: detecting an occurrence of an event; determining diminished reality content that, when displayed, will diminish a reality of the event; determining a delivery channel for the diminished reality content; and deploying the diminished reality content in the delivery channel to diminish the reality of the event.

One or more aspects of the subject disclosure include a method made up of actions that may include detecting, by a processing system including a processor, an occurrence of an event; determining, by the processing system, diminished reality content that, when displayed, will diminish a reality of the event; determining, by the processing system, a delivery channel for the diminished reality content; and deploying, by the processing system, the diminished reality content in the delivery channel to diminish the reality of the event.

Additional aspects of the subject disclosure may include: collecting background imagery in a vicinity of the occurrence of the event, and identifying at least a portion of the background imagery to include in the diminished reality content, wherein the background imagery may be collected prior to, or in response to, detecting the occurrence of the event, wherein the detecting the occurrence of the event comprises detecting a vehicle accident; wherein the determining the delivery channel for the diminished reality content comprises determining an unmanned aerial vehicle as the delivery channel or comprises determining one or more in-vehicle display devices as the as the delivery channel; wherein the deploying the diminished reality content in the delivery channel comprises commanding an unmanned aerial vehicle to project the diminished reality content onto a visual medium; wherein the deploying the diminished reality content in the delivery channel further comprises commanding an unmanned aerial vehicle to deploy the visual medium; and wherein the visual medium may comprise a solid or non-solid projection surface or medium.

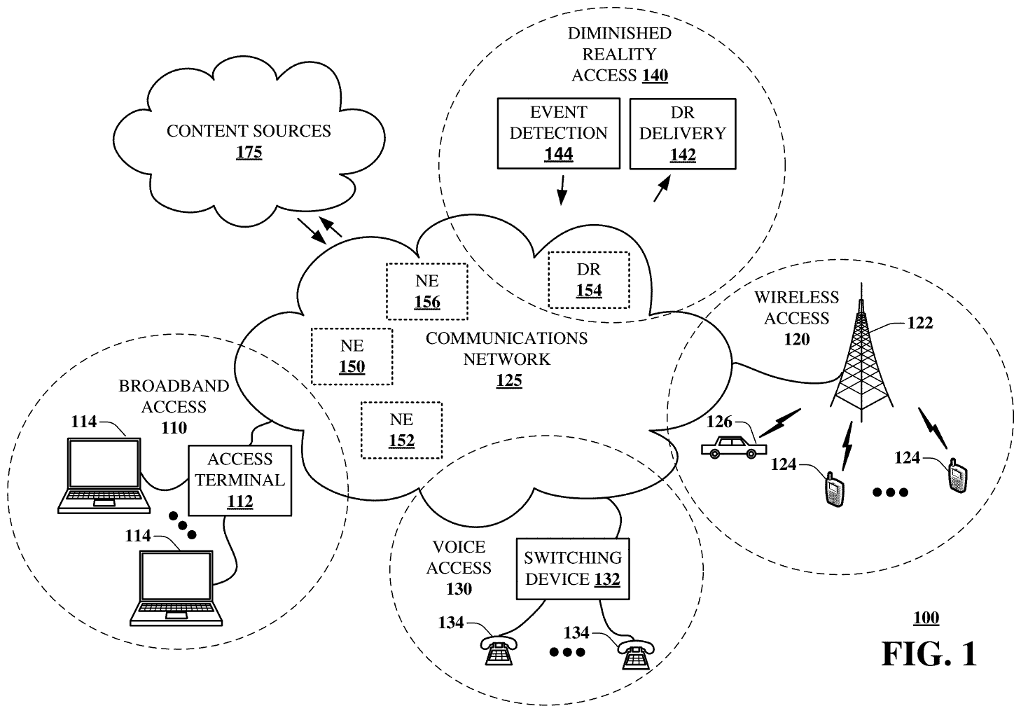

Referring now to FIG. 1, a block diagram is shown illustrating an example, non-limiting embodiment of a system 100 in accordance with various aspects described herein. For example, system 100 can facilitate in whole or in part deploying diminished reality content. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or access 140 to diminished reality services through event detection 144 and diminished reality (DR) service delivery 142. In addition, communication network 125 is coupled to one or more content sources 175 of audio, video, graphics, text and/or other media such as diminished reality content. While broadband access 110, wireless access 120, voice access 130 and diminished reality access 140 are shown separately, one or more of these forms of access can be combined to provide multiple access services to a single client device (e.g., mobile devices 124 can receive diminished reality content via DR delivery 142, data terminal 114 can be provided voice access via switching device 132, and so on).

The communications network 125 includes a plurality of network elements (NE) 150, 152, 156, etc. for facilitating the broadband access 110, wireless access 120, voice access 130, diminished reality access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the content sources 175 include broadcast television and radio sources, video on demand platforms and streaming video and audio services platforms, one or more content data networks, data servers, web servers and other content servers, and/or other sources of media such as diminished reality content.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

In various embodiments, the communications network may include diminished reality services 154 that receive detection of event occurrences 144 and deliver diminished reality content through one or more delivery channels at 142. In some embodiments, DR services may be provided by a network element, a core server, an edge server, a cloud-based server, or the like.

In various embodiments, a system provides for the on-demand scheduling and deployment of a diminished reality replacement (DRR) which includes (a) a target event or scene to replace, (b) a diminished reality replacement view (or content), and (c) a display surface or medium. The target event may be detected at 144 and provided to DR service 154. For example, in some embodiments, an event detection may result from an ad-hoc request for DR services for an event (e.g., any individual or automaton may request a DRR for a given event via contact to a central service). Also for example, in some embodiments, an event detection may result from an unexpected occurrence of a disruptive event (e.g., a traffic camera or self-driving car may detect a roadside crash). In some embodiments, the DR service 154 may determine diminished reality content and deliver that content through a diminished reality delivery channel at 142. Example delivery channels include unmanned aerial vehicles, billboards, smart screens and mobile devices inside vehicles, and the like. Display surfaces or media may include the aforementioned billboards, screens, and mobile devices, and may also include transient or permanent projection surfaces.

In various embodiments, diminished reality content or views may be modified to mask or overlay the troublesome event or modify perception of the troublesome event (e.g., display a normal road-side scene over an actual scene of a road-side accident as if nothing was there), to provide a civic message (e.g., an opaque display obscuring the event), or highlight the event (e.g., for emergency or technical response, update to show the specific need) depending on the proximal viewer. These and other embodiments are further described below.

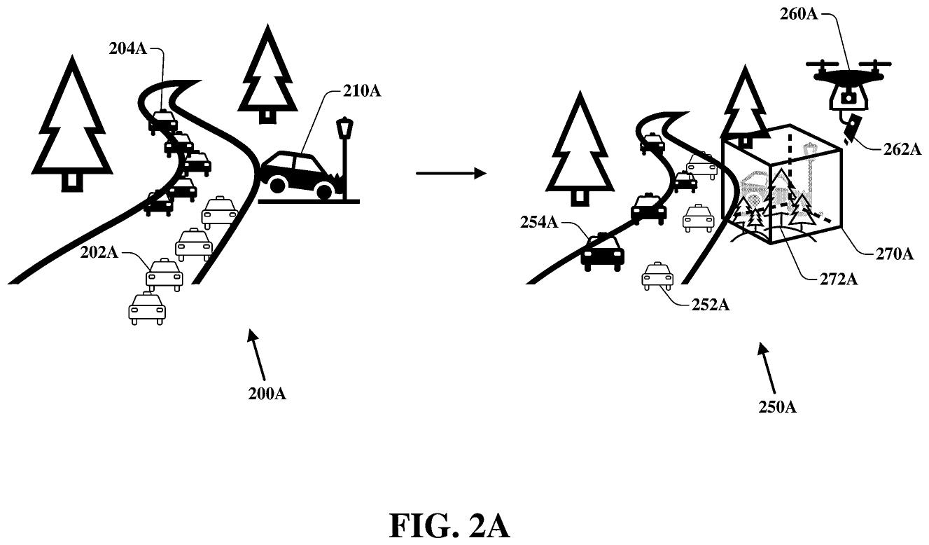

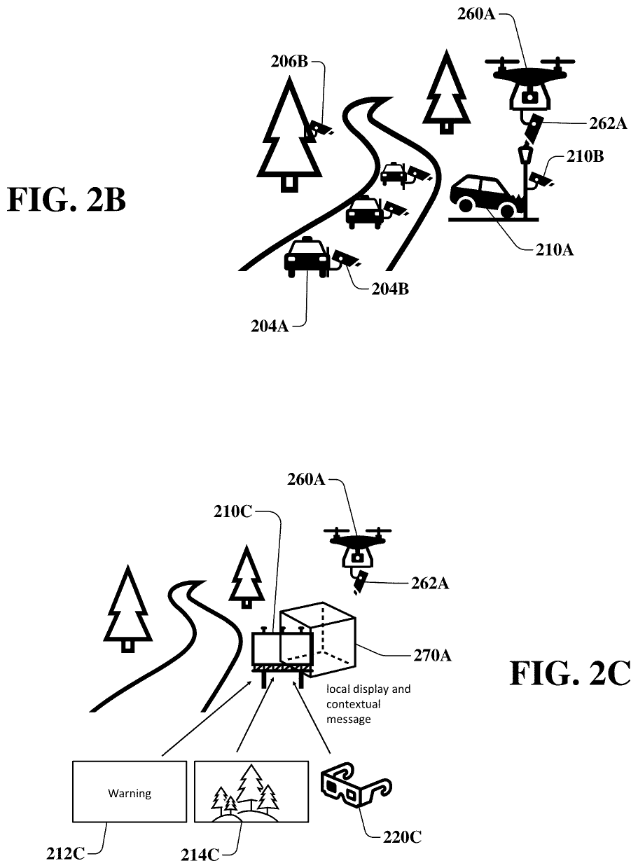

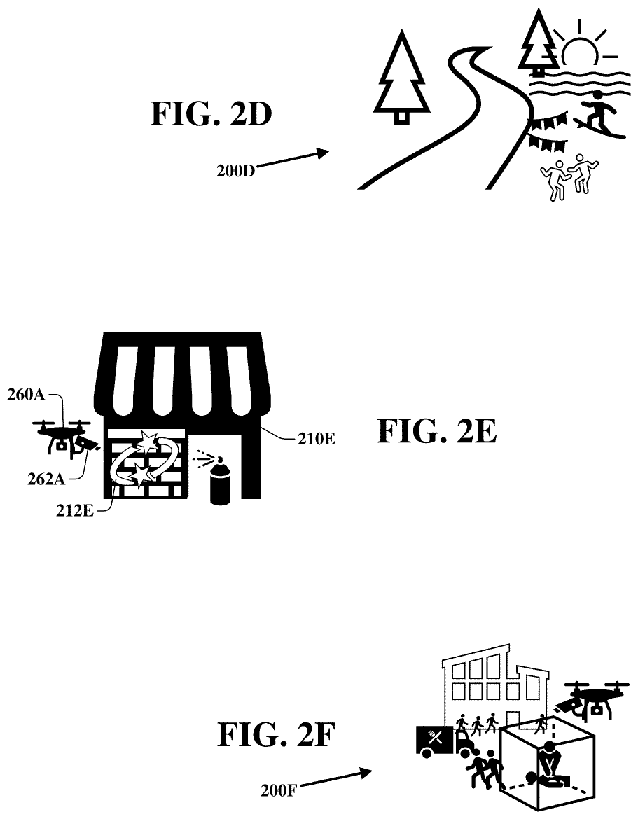

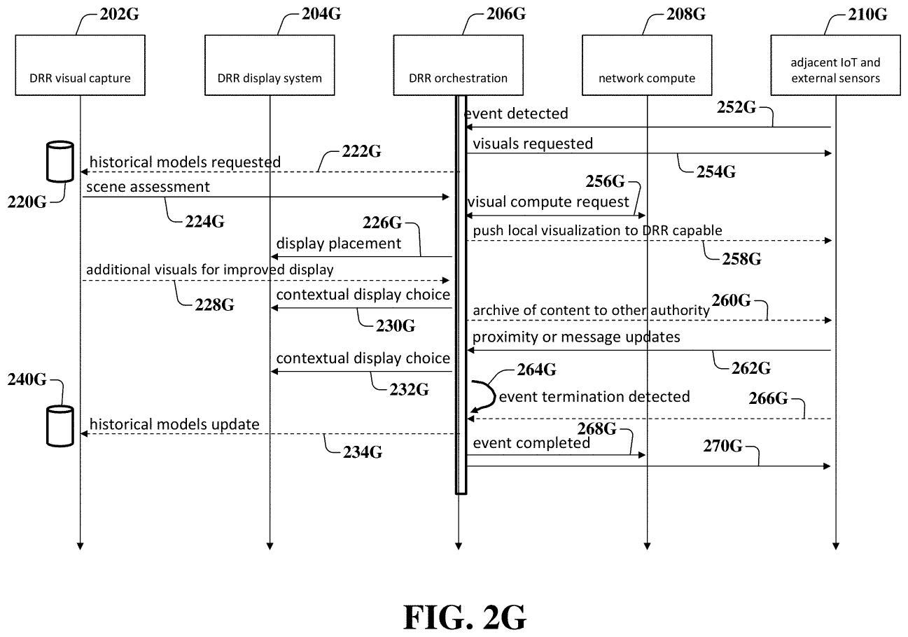

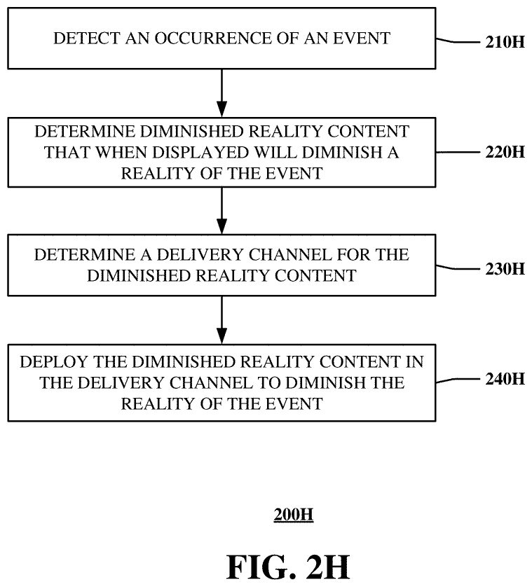

FIG. 2A is a block diagram illustrating operation of an example, non-limiting embodiment of a diminished reality system in accordance with various aspects described herein. As shown at 200A in FIG. 2A, an unexpected event such as a vehicle accident 210A may occur, causing trouble such as traffic congestion 202A, 204A. Typically, troubles caused by the event (congestion, additional accidents) may compound until, and even after authorities arrive or the event is cleared. Instead of letting the event go unaddressed until the appropriate party arrives, various embodiments described herein reduce or eliminate the troubles caused by the event by delivering diminished reality content to overlay or mask the event, or otherwise reduce the effects of the event occurrence on the surrounding environment. For example, as shown at 250A in FIG. 2A, diminished reality content 272A may be delivered on a projection surface 270A by a projector 262A carried by an unmanned aerial vehicle (UAV) 260A. Traffic congestion 252A, 254A is reduced as a result.

In the example of FIG. 2A, the event occurrence may be detected in any manner, for example, automation may be available to detect the troublesome event automatically, via anomalous traffic throughput, a detected visual anomaly in a system, or a self-reported incident from a human participant. For example, an event may be detected by the cars or people in an accident and the delivery mechanism (e.g., UAV 260A) dispatched to their event to shroud the event visuals from future drivers that traditionally cause congestion (and other accidents). Further, the diminished reality content may be delivered through one or more of many different delivery channels, UAV 260A and projection surface 270A being just one example. These and other embodiments are further described below.

In operation, once an event has been reported, the “quarantine” or segregation of the event area begins. Traditionally, this segregation often causes more distractions (e.g. police and emergency vehicles, barriers, etc.) instead of aiding the problem. Existing solutions are covering the event with an opaque tent, surface, or fence—but this is only possible for certain event needs that are large and in a fixed location, such as construction, utility repair, or general roadwork. As an alternate solution, various embodiments described herein construct a diminished reality replacement (DRR) covering one or more views of the event. For example, traffic events may be obscured by a large screen that prevents driver distractions, construction crews may be covered by multi-plane tents and appropriate visuals.

Further, various embodiments deliver diminished reality content through dynamic display technology and contextual awareness. For example, diminished reality content may be delivered in a manner that provides an opaque warning sign for some drivers, but highlight the trouble areas in an event (e.g. the injured parties, fire or safety risks, etc.) for emergency crews. The dynamic display itself may update based on the proximal parties to the event. Various embodiments dispatch high-mobility, highly-dynamic displays to deliver diminished reality content. For example, utilizing displays on-boarded to UAVs (or available ambient signage), the diminished reality content can be delivered and placed for best viewing angle, coverage of the event, display intensity, etc.

The diminished reality content that is delivered may be determined, collected, and/or retrieved from any source and in any manner. For example, in some embodiments, background images, video, and/or audio are continuously collected from various locations and by various devices, so that when the need arises, sources of diminished reality content have stores of content suitable for many different scenarios. Also for example, in some embodiments, just-in-time collection of visuals (images and/or video) from adjacent passive sensors, such as traffic cameras, adjacent IoT devices, autonomous vehicles, or even the dispatched display may provide diminished reality content, thereby reducing the activities associated with omni-present capture (e.g. continuous capture by sensors) or persistent storage of visuals for a single location (e.g. cached images captured by others). In some embodiments, diminished reality content is collected from multiple angles and viewpoints, allowing for any view replacement as desired (e.g., volumetric view replacement or other) to best obscure the event and maintain crowd-based normalcy.

In some embodiments, once diminished reality content is delivered, it may be managed locally. For example, locally managed visuals may render discrete images from various viewpoints and angles using volumetric images. Local management allows for image rendering and modifications without requiring complex pre-configuration of rendering compute allocation beforehand; instead, the display, visual capture, etc., may be locally assessed and utilize cloud- or edge-compute only as necessary.

FIG. 2B is a block diagram illustrating an example, non-limiting embodiment of a diminished reality system with multiple sensors in accordance with various aspects described herein. As shown in FIG. 2B, in some embodiments, images, video, and/or audio may be collected using one or more different sensors, such as on-vehicle cameras 204B, traffic cameras 210B, and other cameras 206B located throughout the environment. This content may be collected before and/or after the event occurrence. In some embodiments, once the DR delivery mechanism (e.g., UAV) is dispatched, the delivery mechanism may collect visuals from ambient sensors (e.g., cameras 204B, 210B, 206B, or other IoT devices) or utilize its own collection service. For example, in some embodiments, the delivery mechanism may include a self-contained collection service (such as one or more sensors attached to a UAV) that can inspect geometric properties of the scene and proactively collect appropriate visual data for construction of the diminished reality content.

FIG. 2C is a block diagram illustrating an example, non-limiting embodiment of a diminished reality system with multiple delivery channels for diminished reality content in accordance with various aspects described herein. As shown in FIG. 2C, delivery channels for diminished reality content may include fixed structures such as billboard 210C, transient structures such as projection surface 270A, and/or personal/mobile items such as eyewear 220C, mobile devices, in vehicle displays, and the like.

In some embodiments, fixed structures may display any content to deliver diminished reality. For example, textual displays such as warning signs 212C may be displayed. Also for example, background images 214C that match the environment may be displayed. Further, in some embodiments, diminished reality content is split between a personal display (e.g., eyewear 220C) and a larger outdoor display (e.g., billboard 210C, surface 270A.

In some embodiments, projection surface 270 is deployed after the event occurrence is detected. For example, in some embodiments, projection surface 270 may be solid surface that is deployed on-site. Examples include a lightweight dome that is deployed from a UAV, a structure that is deployed by a first responder, or the like. The projection surface may be solid or non-solid. For example, the projection surface may be a lightweight fabric, a fog, or a mist. Any surface, solid or not, may be used to support display of diminished reality content.

FIGS. 2D-2F are block diagrams illustrating additional example, non-limiting embodiments of diminished reality systems in accordance with various aspects described herein. As shown at 200D in FIG. 2D, an event occurrence may include any type of event that may benefit from delivery of diminished reality content. Examples include, but are not limited to, a surfing competition and/or an outdoor festival. Temporary events such as these that can be seen from afar may distract drivers and pedestrians, and modifying their perception of reality through the delivery of diminished reality content may improve safety. In some embodiments, the diminished reality system may be utilized to obscure and replace this view with an appropriate one to reduce congestion—or alternatively to provide information—instead of introducing confusion and frustration for proximal individuals.

Similarly, as shown in FIG. 2E, various embodiments may mask graffiti 212E on a structure 210E. The occurrence of a graffiti event may be detected using automated systems, such as cameras, or may be reported by a person. In response, the appropriate diminished reality content is determined, deployed, and delivered to modify the perception of reality in the vicinity of the event. In some embodiments, diminished reality may be accomplished without the use of a secondary screen or projections surface if projection is applied to an existing surface (e.g., structure 210E) with lighting chosen for removal/cancellation of patterns.

The delivery channel may include a UAV as shown in FIG. 2E, or may include any other delivery channel capable of delivering diminished reality content, such as a vehicle-mounted projector, a projector co-located with a traffic camera, or the like.

As shown at 200F in FIG. 2F, the occurrence of road-side emergencies beyond vehicle accidents may be considered events. For example, a building fire, or a medical emergency may be determined to be an event occurrence that warrants the delivery of diminished reality content. In some embodiments, a civic message (“warning: speed reduced”) may be displayed, or the diminished reality content may erase the event entirely (replace a roadside with the grassy knoll or urban scene that normally exists).

Further, in some embodiments, temporary repair scenarios such as construction and utility crews on buildings and in road conditions additionally distract drivers and proximal pedestrians, the perception of which may be modified by the delivery of diminished reality content. In some embodiments, for large, static events (e.g., construction of a new high-rise), a fence or scaffold may be erected, and the delivery of diminished reality content may include projection or display on the fence or scaffold.

FIG. 2G is a diagram illustrating operation of example, non-limiting embodiments of diminished reality systems in accordance with various aspects described herein. FIG. 2G includes DRR visual capture 202G, DRR display system 204G, DRR orchestration 206G, network compute 208G, and adjacent IoT and external sensors 210G. DRR visual capture 202G may include any device or network element capable of capturing images and or video useful to be deployed as diminished reality content. For example, DRR visual capture 202G may include storage of images and video useful for inclusion as diminished reality content. In some embodiments, DRR visual capture 202G continuously captures background images, video, and or audio of environments in which events may be expected to occur that may benefit from diminished reality content delivery. For example, DRR visual capture 202G may continuously capture background images at various locations and times of day in different seasons to maintain a library of diminished reality content that may be utilized when needed based on time of day, season, and location of event occurrences.

DRR display system 204G may include a delivery mechanism capable of delivering and/or displaying diminished reality content. For example, DRR display system 204G may include UAV 260B. Also for example, DRR display system 204G may include a deployable projection surface and or a fixed display surface capable of displaying diminished reality content. Examples include lightweight structures deployable by a UAV, lightweight structures deployable by emergency personnel, fixed structures such as billboards, as well as mobile devices or personal devices on scene or inside vehicles.

DRR orchestration 206G maybe a server that implements processes to orchestrate the detection of event occurrences, determining appropriate diminished reality content, and commanding DRR display system 204G to deliver the diminished reality content as a diminished reality delivery channel. Network compute function 208G may be a process running on a server capable of performing graphical image computations to generate actual images and/or videos to be delivered as diminished reality content. Adjacent IoT and external sensors 210G may include any devices in the ambient environment capable of detecting event occurrences, collecting visuals useful for diminished reality content, and the like. Examples include vehicle mounted cameras, traffic cameras, in vehicle crash sensors, and cloud based congestion algorithms capable of determining traffic congestion.

In some embodiments, DRR orchestration 206G and network compute 208G are combined into a single entity, such as a server within a communication system such as DR server 154. In other embodiments, DRR orchestration 206G and network compute 208G are performed by separate entities. For example, one may be within a communications network while the other may be an edge based server or a cloud based server. Further, DRR visual capture 202G and adjacent IoT and external sensors 210G may include one or more common elements. For example, an external sensor may be used for visual capture. In some embodiments, DRR visual capture 202G includes storage of diminished reality content as further explained below.

In operation, DRR orchestration 206G detects the occurrence of an event. In some embodiments, human participants in the event may request a DRR for the event, and in other embodiments, one or more automated systems may detect the occurrence of the event. For example, a crash sensor in a vehicle may detect the occurrence of an event, or a traffic camera may detect the occurrence of an event.

At 254G, DRR orchestration 206G may request that adjacent IoT and external sensors 210G capture images of the event to understand the size and magnitude for planning of DRR resources. In some embodiments, DRR orchestration 206G may request historical views of the event location at 222G (e.g., from a database 220G of previously collected imagery or from IoT that were just in the area) to determine the diminished reality content to deliver, and then request that diminished reality content be determined and/or computed at 256G in response to a scene assessment received at 224G. Further, in some embodiments, DRR orchestration 206G may use historically constructed views from prior events (e.g. visual models already built for this location) as diminished reality content to deliver.

A delivery channel is determined to deliver the diminished reality content. For example, at 258G, if an IoT device or sensor is capable of delivering diminished reality content, the diminished reality content may be “pushed” to the DRR capable device already on scene. The DRR may push a region-based visual update to oncoming IoT such that their displays can update with the diminished reality content as well (e.g., replacement visuals can be pushed to vehicles and goggles capable of DRR methods such that they will locally replace views for their users). Also for example, at 226G, a delivery channel that may include a deployable mechanism may be chosen to as a delivery channel. Examples include deployable projection surfaces and mobile projectors. In some embodiments, deployable projection surfaces are deployed by a UAV and the same UAV projects the diminished reality content on the projection surface. In other embodiments, a deployable projection surface is deployed by a first UAV and diminished reality content is projected on the projection surface by a second UAV that includes a projector. In still further embodiments, a first responder may deploy a projection surface, and diminished reality content may be projected either by the first responder or by a UAV.

In some embodiments, the deployed delivery channel may collect additional imagery and include some or all of that imagery in the diminished reality content. For example, a UAV may include a camera, and may combine imagery 228G received by the camera with diminished reality content provided by the DRR system. In some embodiments, with additional assessment, the DRR system may accumulate imagery and construct a volume-based visual for visual replacement of the event (e.g. DRR from any vantage point).

Once a delivery channel is determined, the DRR system may command a delivery mechanism in the delivery channel to deliver the diminished reality content. For example, a UAV may be deployed with a deployable projection surface, and the display may be configured and enabled—the orientation of the display and the expected perturbations (e.g. wind, rain, other effects) may be included in the display.

In some embodiments, the DRR system may report the event occurrence and actions to other entities. For example, the DRR system may push visuals at 260G to an external source for subsequent review (e.g., police report visuals, report anomaly on building, etc.) or automation (e.g. request pedestrian or car traffic reroute to avoid the location).

In some embodiments, the DRR system may update contextual message over time. For example, a contextual display choice may be made at 230G, 232G, or at other stages of the deployment and delivery of diminished reality content. In some embodiments, contextual display choices may be made upon detection of proximal entities at 262G, and the visual may change to best satisfy local users (e.g. change to highlight the anomalous objects or conditions—like car object, fire event, or dangerous utility or building condition). In some embodiments, the DRR system may receive external (authorized) messaging for an event that instructs local viewers, as determined manually or automatically by central system or contributors, and the DRR system may temporarily alert other individuals not in event of exiting/entering individuals (e.g. warning sign that construction crew is departing) as needed.

In some embodiments, the DRR system may determine when an event occurrence is completed at 264G, and in other embodiments, one or more IoT/vehicles or sensors may determine when the event occurrence is completed. For example, a vehicle sensor may signal repair or movement from the location; similarly a human authority may indicate the condition is all clear.

In some embodiments, the DRR system may store replacement visuals 234G in a database 240G for use in subsequent event occurrences so that visual DRR can be reused more quickly in future events.

In some embodiments, the DRR system may record and report on-the-scene data. In some embodiments, a visual sample of the space before and after the event may be useful when constructing the diminished reality content; this data can be timestamped and the specific objects that were identified by the DRR process can reported for civil actions (e.g. a police report) in high detail (e.g. multi-view volumetric video).

In some embodiments, the diminished reality content may be updated to be volumetric in nature such that viewing the event from any side results in the same consistent view (e.g. the DRR-resolved output of the event).

In some embodiments, the locally managed DRR system may request assistance from other IoT or automation to reconfigure or restructure nearby surfaces or walls; for example, in a road-side incident, the DRR system may identify that a crash was in the far left lane of a highway, and then request that highway lighting and sensoring reconfigure traffic lanes leading to the event site, thereby reducing congestion at the event occurrence site.

Further, in some embodiments, the diminished reality content may be utilized as a temporary advertisement display; while adhering to local civic requirements for a display (e.g., brightness, size, scale, update frequency) a portion of the display may be repurposed for this intent if locally approved.

In still further embodiments, the diminished reality content may be augmented with audio-replacement technology as well (e.g., noise cancellation, alternate sound replacement, etc.).

FIG. 2H depicts an illustrative embodiment of a method in accordance with various aspects described herein. An occurrence of an event is detected at 210H of method 200H. The event may be an unexpected event, such as a vehicle accident, or may be an expected event such as a large gathering for a competition or a carnival. The occurrence of the event may be detected in any manner. For example, a sensor in an electronic system may provide a trigger that is interpreted as an event occurrence. Example sensors may include accelerometers, cameras, microphones, or the like. Also for example, metadata may be analyzed to detect the occurrence of an event. An example of metadata useful for detecting a vehicle accident may include velocity data related to mobile devices useful to detect congestion on a roadway that results from a vehicle accident.

In some embodiments, the occurrence of an event is detected in response to an alert that is sent requesting diminished reality content services. For example, a person involved in a vehicle accident may place a call that is interpreted as the occurrence of an event. Also for example, a first responder may actively request diminished reality services in response to the occurrence of an event.

At 220H, method 200H determines diminished reality content that, when displayed, will diminish a reality of the event. In some embodiments, this corresponds to collecting imagery, video, and/or audio from the scene of the event in response to detecting the occurrence of the event. In other embodiments, the actions of 220H correspond to requesting imagery, video, and/or audio from a database that includes past collections of visual data. In some embodiments, the past collections of visual data may match a time of day, a season, or any other attribute useful in matching the diminished reality content with the ambient surroundings at the event site. In some embodiments, graphics processing algorithms are applied to past visual data to arrive at the actual diminished reality content that will be displayed at the event site. For example, in some embodiments, the diminished reality content may be computed to be viewable from multiple angles and or viewpoints or may be designed to change dynamically as a user's viewpoint changes.

At 230H, a delivery channel for the diminished reality content is determined. In some embodiments, this corresponds to selecting a fixed display location such as a billboard to display the diminished reality content. In other embodiments, this corresponds to selecting a mobile deployment mechanism such as a vehicle or a UAV to serve as the delivery channel for the diminished reality content. As described above, the delivery channel mechanism may also deploy a projection surface upon which the diminished reality content may be projected. In some embodiments, the projection surface is deployed by the same mechanism that projects the diminished reality content, and in other embodiments, the display surface is deployed by a mechanism separate from the mechanism that projects the diminished reality content. In some embodiments, the projection surface may be solid such as a lightweight structure capable of being projected upon, and in other embodiments, the projection surface may be non-solid such as a fog or a mist or a rain that may support display of projected content. Further, in some embodiments, a projection surface may take a shape related to the diminished reality content. For example, a deployed projection surface may be in the shape of a tree, a vehicle, a building, or any other shape that when projected upon may enhance the diminished reality experience.

At 240H, the diminished reality content is deployed in the delivery channel to diminish the reality of the event. In some embodiments, this corresponds to a diminished reality replacement system commanding a mechanism within a delivery channel to project diminished reality content on a projection surface. For example, a DR server may command a UAV to project diminished reality content on a deployed projection surface.

While for purposes of simplicity of explanation, the respective processes are shown and described as a series of blocks in FIG. 2H, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

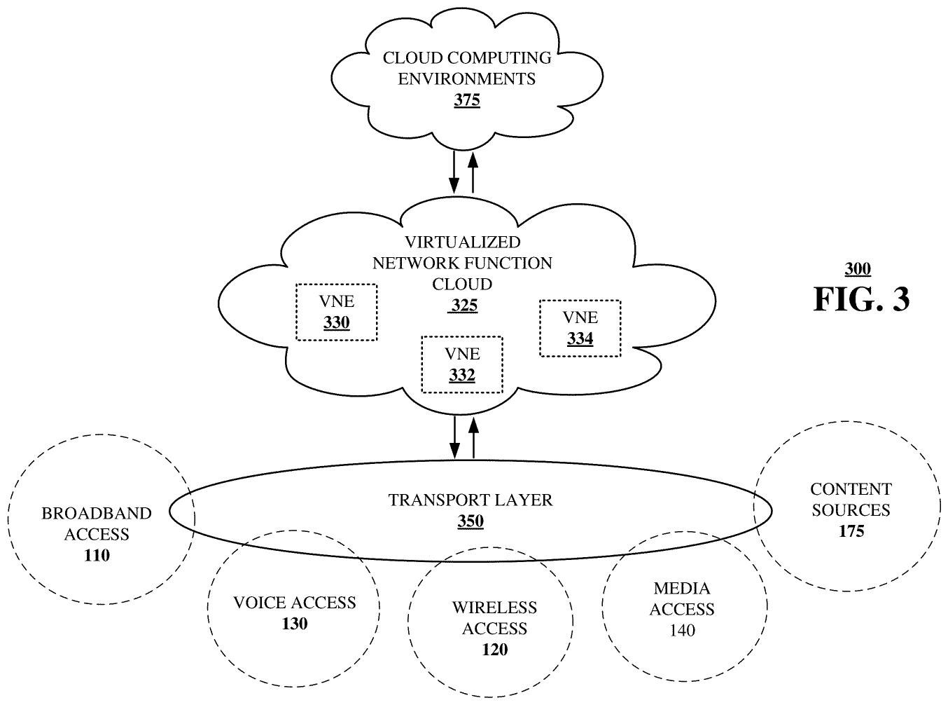

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of the systems and methods presented herein. For example, virtualized communication network 300 can facilitate in whole or in part deploying diminished reality content.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general purpose processors or general purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it's elastic: so the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements don't typically need to forward large amounts of traffic, their workload can be distributed across a number of servers—each of which adds a portion of the capability, and overall which creates an elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

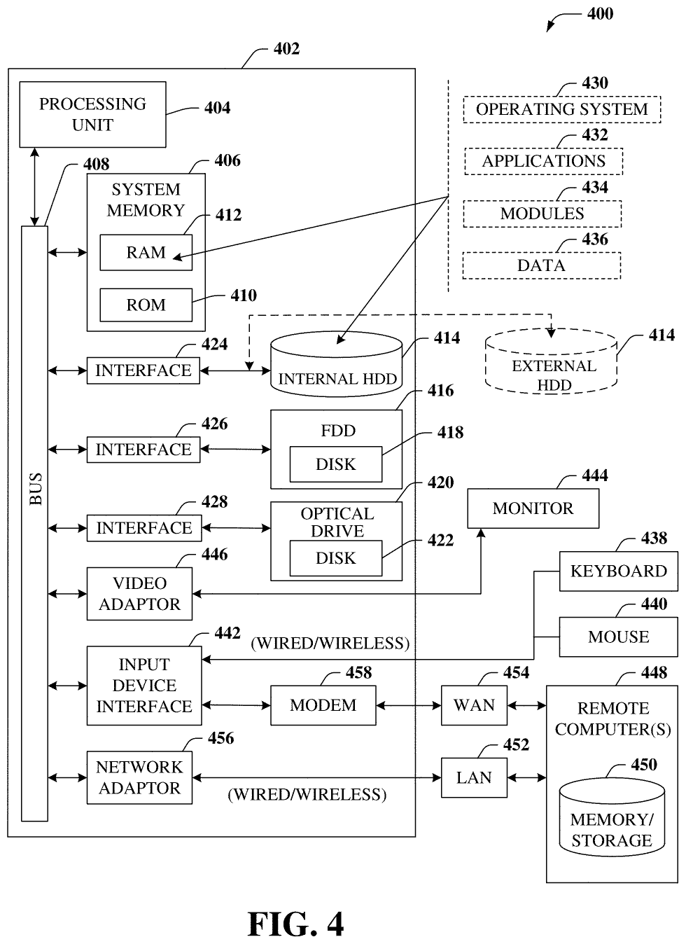

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part deploying diminished reality content.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

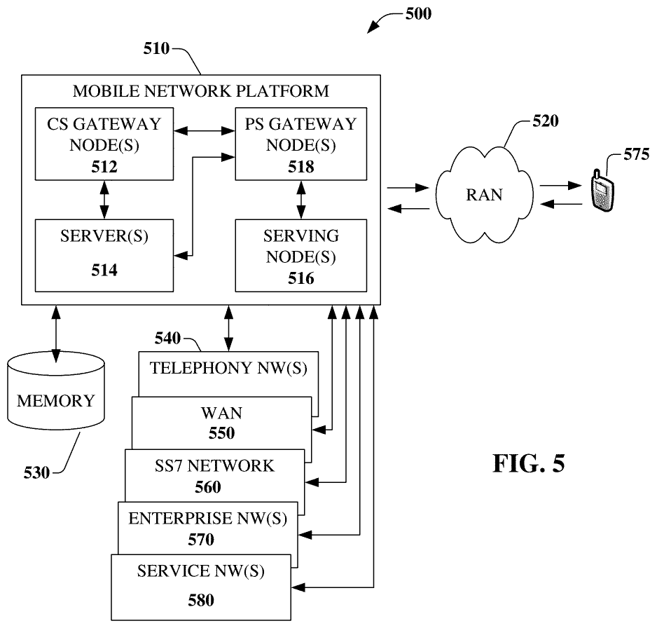

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part deploying diminished reality content. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processor can execute code instructions stored in memory 530, for example. It is should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

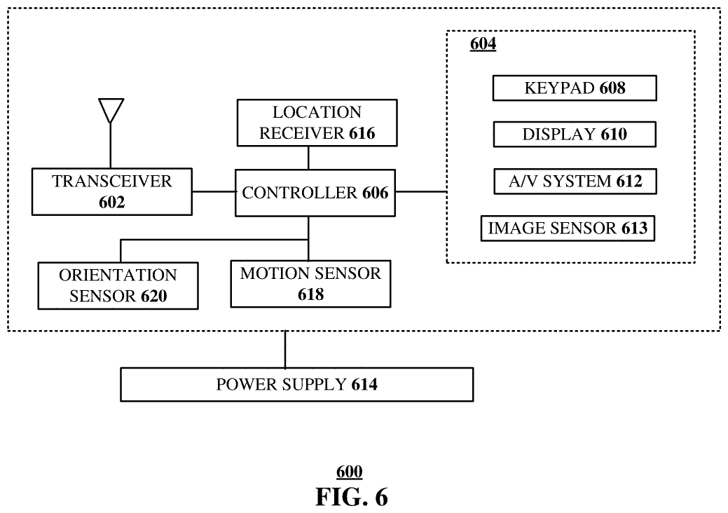

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part deploying diminished reality content.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, WiFi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, WiFi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

1. A device, comprising:
a processing system including a processor; and
a memory that stores executable instructions that, when executed by the processing system, facilitate performance of operations, the operations comprising:
detecting an occurrence of an event;
determining diminished reality content that, when displayed, will diminish a reality of the event;
determining a plurality of delivery channels for the diminished reality content wherein the plurality of delivery channels includes a fixed structure, a transient structure, a personal device, a mobile device, or a combination thereof; and
deploying the diminished reality content in the plurality of delivery channels to diminish the reality of the event;
wherein the determining the diminished reality content comprises determining different content of the diminished reality content for the event based on context of the event and proximity of the plurality of delivery channels to the event;
wherein the deploying further comprises:
deploying first content of the diminished reality content that highlights reality of the event;
deploying second content of the diminished reality content that obscures the reality of the event; and
deploying third content of the diminished reality content that replaces the reality of the event with another content.

2. The device of claim 1, wherein the operations further comprise collecting background imagery in a vicinity of the occurrence of the event, and wherein the determining the diminished reality content comprises identifying at least a portion of the background imagery.

3. The device of claim 2, wherein the collecting background imagery comprises collecting the background imagery prior to the detecting the occurrence of the event.

4. The device of claim 2, wherein the collecting background imagery comprises collecting the background imagery in response to the detecting the occurrence of the event.

5. The device of claim 1, wherein the detecting the occurrence of the event comprises detecting a vehicle accident.

6. The device of claim 1, wherein the determining the plurality of delivery channels for the diminished reality content comprises determining an unmanned aerial vehicle as one of the plurality of delivery channels.

7. The device of claim 6, wherein the deploying the diminished reality content in the plurality of delivery channels comprises commanding the unmanned aerial vehicle to project the diminished reality content onto a visual medium.

8. The device of claim 7, wherein the deploying the diminished reality content in the delivery channel further comprises commanding the unmanned aerial vehicle to deploy the visual medium.

9. The device of claim 7, wherein the visual medium comprises a solid projection surface.

10. The device of claim 7, wherein the visual medium comprises a non-solid projection surface.

11. The device of claim 1, wherein the determining the plurality of delivery channels for the diminished reality content comprises determining one or more in-vehicle display devices as one of the plurality of delivery channels.

12. A non-transitory, machine-readable medium, comprising executable instructions that, when executed by a processing system including a processor, facilitate performance of operations, the operations comprising:
detecting an occurrence of an event;
determining diminished reality content that, when displayed, will diminish a reality of the event;
determining a delivery channel for the diminished reality content, the delivery channel including a public structure, a personal device, or a combination thereof; and
deploying the diminished reality content in the delivery channel to diminish the reality of the event;
wherein the determining the diminished reality content comprises determining different content of the diminished reality content for the event based on context of the event;
wherein the deploying further comprises:
deploying first content of the diminished reality content that highlights reality of the event;
deploying second content of the diminished reality content that obscures the reality of the event;
deploying third content of the diminished reality content that replaces the reality of the event with another content; and
splitting the diminished reality content between the public structure and the personal device by deploying the first content on the public structure and deploying the third content on the personal device.

13. The non-transitory, machine-readable medium of claim 12, wherein the detecting the occurrence of the event comprises detecting a vehicle accident.

14. The non-transitory, machine-readable medium of claim 12, wherein the determining the delivery channel for the diminished reality content comprises determining an unmanned aerial vehicle as the delivery channel.

15. The non-transitory, machine-readable medium of claim 14, wherein the deploying the diminished reality content in the delivery channel comprises commanding the unmanned aerial vehicle to project the diminished reality content onto a visual medium.

16. The non-transitory, machine-readable medium of claim 15, wherein the deploying the diminished reality content in the delivery channel further comprises commanding the unmanned aerial vehicle to deploy the visual medium.

17. A method, comprising:
detecting, by a processing system including a processor, an occurrence of an event;
generating a plurality of different coverage for a detected event;
determining, by the processing system, diminished reality content that, when displayed, will diminish a reality of the event;
determining, by the processing system, a delivery channel for the diminished reality content; and
deploying, by the processing system, the diminished reality content in the delivery channel to diminish the reality of the event;
wherein the determining the diminished reality content comprises determining different content of the diminished reality content in response to the plurality of different coverage for the detected event, context of the event and proximity of the delivery channel to the event;
wherein the deploying further comprises:
deploying first content of the diminished reality content that highlights reality of the event;
deploying second content of the diminished reality content that obscures the reality of the event; and
deploying third content of the diminished reality content that replaces the reality of the event with another content.

18. The method of claim 17, wherein the determining the delivery channel for the diminished reality content comprises determining an unmanned aerial vehicle as the delivery channel.

19. The method of claim 18, wherein the deploying the diminished reality content in the delivery channel comprises commanding the unmanned aerial vehicle to project the diminished reality content onto a visual medium.

20. The method of claim 19, wherein the deploying the diminished reality content in the delivery channel further comprises commanding the unmanned aerial vehicle to deploy the visual medium.
